(19) United States
(12) Patent Application Publication
(10) Pub. No.: US 2026/0260572 A1
(43) Pub. Date: Sep. 3, 2026

(54) SYSTEM AND METHOD FOR ARTIFICIAL INTELLIGENCE-BASED INTERACTIVE VIDEO LEARNING

(71) Applicant: Pearson Education, Inc., Bloomington, MN (US)

(72) Inventor: Laddu Harshitha Kasun Keerthi DE SILVA, Concord, NC (US)

(21) Appl. No.: 19/552,748

(22) Filed: Feb. 27, 2026

Related U.S. Application Data
(60) Provisional application No. 63/765,008, filed on Feb. 28, 2025.

(51) Int. Cl. G09B 5/06; G06V 10/764; G06V 10/82; G09B 7/02; G09B 7/06

(52) U.S. Cl. CPC G09B 5/06; G06V 10/764; G06V 10/82; G09B 7/02; G09B 7/06

(57) ABSTRACT

Systems and methods of generating an enriched learning content perform and/or comprise ingesting, by a cloud services platform, a multimedia content, wherein the multimedia content includes a video content; generating, by at least one artificial intelligence (AI) model of the cloud services platform and based on a prompt input from a user, an interactive content; presenting a preview of the interactive content to the user; and merging the multimedia content and the interactive content to produce the enriched learning content.

### CROSS-REFERENCE TO RELATED APPLICATIONS

This application claims priority to and the benefit of U.S. Provisional Application No. 63/765,008, filed on Feb. 28, 2025, the entire contents of which are herein incorporated by reference for all purposes.

### TECHNICAL FIELD

This disclosure relates to the field of systems and methods for use within an electronic learning environment, and specifically to systems and methods configured to provide an artificial intelligence-based framework by which an instructor may create and disseminate content-rich interactive video learning materials.

### SUMMARY

According to one aspect of the present disclosure, A method of generating an enriched learning content is provided. The method comprises ingesting, by a cloud services platform, a multimedia content, wherein the multimedia content includes a video content; generating, by at least one artificial intelligence (AI) model of the cloud services platform and based on a prompt input from a user, an interactive content; presenting a preview of the interactive content to the user; and merging the multimedia content and the interactive content to produce the enriched learning content.

According to another aspect of the present disclosure, a system for generating an enriched learning content is provided. The system comprises a memory; and a processor coupled with the memory, wherein the processor is configured to: ingest, by a cloud services platform in communication with the processor and the memory, a multimedia content, wherein the multimedia content includes a video content; generate, by at least one artificial intelligence (AI) model of the cloud services platform and based on a prompt input from a user, an interactive content; present a preview of the interactive content to the user; and merge the multimedia content and the interactive content to produce the enriched learning content.

According to another aspect of the present disclosure, a non-transitory computer-readable medium is provided. The non-transitory computer-readable medium stores instructions that, when executed by a processor of a computing node associated with a cloud services platform, cause the computing node to perform operations comprising: ingesting, by a cloud services platform, a multimedia content, wherein the multimedia content includes a video content; generating, by at least one artificial intelligence (AI) model of the cloud services platform and based on a prompt input from a user, an interactive content; presenting a preview of the interactive content to the user; and merging the multimedia content and the interactive content to produce the enriched learning content.

The above features and advantages of the present invention will be better understood from the following detailed description taken in conjunction with the accompanying drawings.

### BRIEF DESCRIPTION OF THE DRAWINGS

FIG. 1 is a block diagram illustrating an example of a content distribution network in accordance with the present disclosure.

FIG. 2 is a block diagram illustrating a computer server and computing environment within a content distribution network in accordance with the present disclosure.

FIG. 3 is a block diagram illustrating an example of one or more data store servers within a content distribution network in accordance with the present disclosure.

FIG. 4 is a block diagram illustrating an example of one or more content management servers within a content distribution network in accordance with the present disclosure.

FIG. 5 is a block diagram illustrating an example of physical and logical components of a special-purpose computer device within a content distribution network in accordance with the present disclosure.

FIG. 6 is a block diagram illustrating one example of a communication network in accordance with the present disclosure.

FIG. 7 is a flowchart illustrating one example of a system of generating interactive video learning content in accordance with the present disclosure.

FIG. 8 is a flowchart illustrating one example of a method of generating interactive video learning content in accordance with the present disclosure.

FIG. 9 is an image illustrating one example of a GUI presentation in accordance with the present disclosure.

FIG. 10 is an image illustrating one example of a GUI presentation in accordance with the present disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

In addition to material that will be discussed or reviewed during a course lesson, many instructors assign learning materials such as homework questions, video reviews, and the like. These learning materials may be associated with additional content, such as video summaries. Instructors spend excessive time manually creating such learning materials and associated content. Moreover, comparative methods suffer from limited personalization; for example, it is difficult or impossible to tailor content to diverse learner needs and learning levels due to manual creation constraints. The comparative methods also suffer from reduced engagement and effectiveness; for example, comparative methods do not adequately support deep learning engagement or adapt to different student learning styles. The above problems are especially true when the learning materials and/or additional content are presented in electronic form, such as content-rich video materials. For example, in order to tailor the electronic content to an individual learner (e.g., to an individual learner's individual needs and/or individual learning style), an instructor would need to generate individualized electronic content for each and every learner, thus requiring a large amount of processing resources (e.g., to generate the individualized videos), storage resources (e.g., to store each individualized video), and transmission resources (e.g., to transmit and/or stream the individualized videos to each learner) in addition to the time cost to the instructor. In medium-or large-sized learning environments (e.g., a course having dozens of students or more), these resource costs may be prohibitive.

The systems, methods, and devices disclosed herein address the above and other needs using, among other things, generative AI models to drive content creation based on an uploaded multimedia item, such as a video. In examples, the systems, methods, and devices set forth herein may automatically generate multiple-choice questions, enable authoring with selectable question counts and distractor options, provide support for timestamp-based question generation, and/or allow customization of difficulty levels for questions. The systems, methods, and devices set forth herein may operate to produce AI-driven enhanced learning materials from the multimedia item, such as video summaries for learners and/or open-ended questions for deeper learning engagement. Moreover, the systems, methods, and devices set forth herein permit quality assurance checks, for example by implementing a human review workflow to allow instructors to review, modify, and attach questions to the multimedia item.

Accordingly, the systems, methods, and devices according to the present disclosure provide several advantages, including but not limited to increasing learner engagement with the learning resources, reducing computing and other costs associated with large amounts of individualized multimedia learning content, and improving the efficiency and reliability of electronic learning environments.

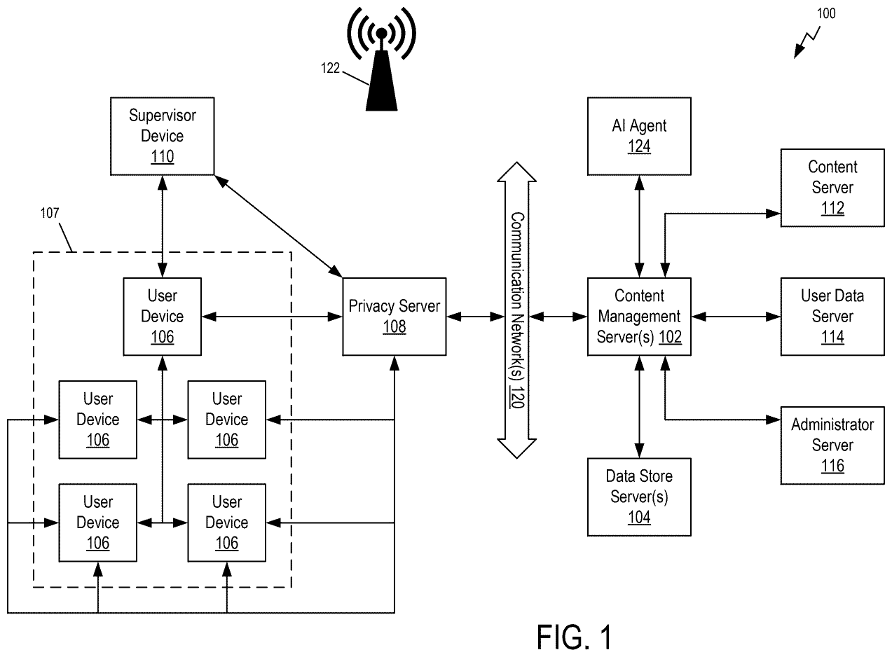

With reference now to FIG. 1, a block diagram is shown illustrating various components of a content distribution network (CDN) 100 that implements and supports certain aspects and features described herein. In some aspects, the content distribution network 100 can comprise one or several physical components and/or one or several virtual components such as, for example, one or several cloud computing components. In some aspects, the content distribution network 100 can comprise a mixture of physical and cloud computing components.

Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 102 may include one or more server farms, clusters, or any other appropriate arrangement and/or combination of computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some aspects, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some aspects, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some aspects, the one or several hardware and/or software components of the database server 104 can be arranged into one or several storage area networks (SAN), which one or several storage area networks can be one or several dedicated networks that provide access to data storage, and particularly that provide access to consolidated, block level data storage. A SAN typically has its own network of storage devices that are generally not accessible through the local area network (LAN) by other devices. The SAN allows access to these devices in a manner such that these devices appear to be locally attached to the user device.

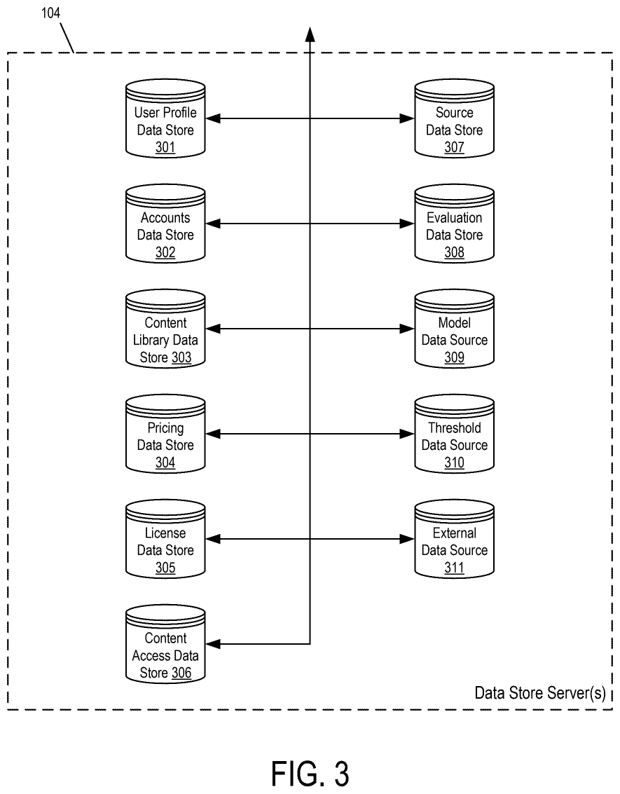

Data stores 104 may comprise stored data relevant to the functions of the content distribution network 100. Illustrative examples of data stores 104 that may be maintained in certain embodiments of the content distribution network 100 are described below in reference to FIG. 3. In some aspects, multiple data stores may reside on a single server 104, either using the same storage components of server 104 or using different physical storage components to assure data security and integrity between data stores. In other aspects, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), near-field communication (NFC), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming systems, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated Secure Socket Layer (SSL) and Secure Hypertext Transfer Protocol (HTTPS), WS-Security, firewalls, etc.) to communicate with the content management server 102 and/or other remotely-located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including his or her user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO, or the like, or location systems or features including, for example, one or several transceivers that can determine location of the one or several components of the content distribution network 100 via, for example, triangulation. All of these are depicted as navigation system 122.

In some embodiments, navigation system 122 can include one or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

The content distribution network 100 may include one or several artificial intelligence agents 124, also referred to herein as an AI agent 124, intelligence agent 124, and IA agent 124. The AI agent 124 can be an autonomous entity that can receive inputs via one or several sensors or from one or several user devices and can provide responses to those received inputs. In some embodiments, the AI agent 124 can comprise a question answering computing system, all or portions of an intelligent tutoring system, pedagogical agent, or the like. In some embodiments, the functioning of the AI agent 124 can be predicated upon artificial intelligence, generative artificial intelligence, machine learning, large language models (LLMs), or the like. The AI agent 124 can reside in the server 102 and/or another component of the content distribution network 100, or can reside on a separate server or on separate computing resources. The AI agent 124 can be configured to receive inputs from the user device 106. The AI agent 124 can further launch a dialogue based on the received inputs and identify a remediation dialogue based on the received user inputs. In some embodiments, the AI agent 124 can determine termination of the dialogue and/or the remediation dialogue based on a user performance metric indicative of a user skill level.

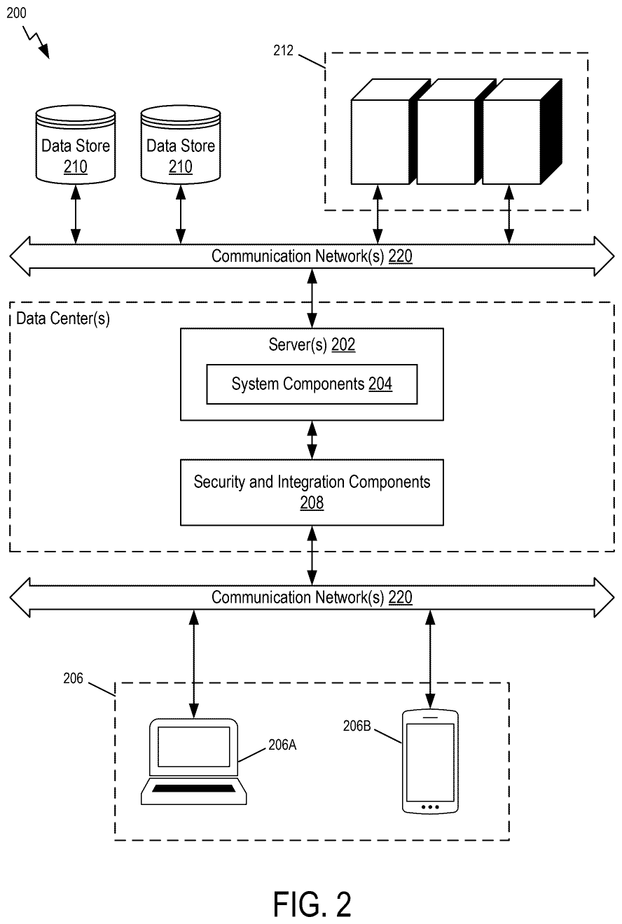

With reference to FIG. 2, an illustrative distributed computing environment 200 is shown. In some examples, the distributed computing environment 100 may include one or more computer servers 202 (e.g., data servers, computing devices, computers, etc.), one or more client computing devices 206, and other components that may implement certain aspects and features described herein. Although exemplary computing environment 200 is shown with two client computing devices 206, any number of client computing devices may be supported. In some implementations, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Other devices, such as specialized sensor devices, etc., may interact with the client computing devices 206 and/or the servers 202. The servers 202, the client computing devices 206, or any other devices may be configured to implement a client-server model or any other distributed computing architecture. In some examples, the servers 202, the client computing devices 206, and any other disclosed devices may be communicatively coupled via one or more communication networks 220.

Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the SSL or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

The communication networks 220 may be any type of network known in the art supporting data communication. As examples, network 220 may be a LAN (e.g., Ethernet, Token-Ring, etc.), a wide-area network (WAN; e.g., the Internet), an infrared or wireless network, a public switch telephone network (PSTN), a virtual network, etc. The network 220 may use any available protocols, including but not limited to transmission control protocol/Internet protocol (TCP/IP), systems network architecture (SNA), Internet packet exchange (IPX), SSL, Transport Layer Security (TLS), HTTP, HTTPS, Institute of Electrical and Electronics (IEEE) 802.11 protocol suite or other wireless protocols, and the like.

Computing environment 200 also may include one or more data stores 210 and/or backend servers 212. In certain examples, the data stores 210 may correspond to data store server(s) 104 discussed above in FIG. 1, and back-end servers 212 may correspond to the various backend servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a SAN, or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-311 may reside in storage on a single computer server 104 (or a single server farm or cluster) under the control of a single entity, or may reside on separate servers operated by different entities and/or at remote locations. In some embodiments, data stores 301-311 may be accessed by the content management server 102 and/or other devices and servers within the network 100 (e.g., user devices 106, supervisor devices 110, administrator servers 116, etc.). Access to one or more of the data stores 301-311 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-311, including their functionality and types of data stored therein, are illustrative and non-limiting. Data stores server architecture, design, and the execution of specific data stores 301-311 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some aspects, this information can relate to one or several individual end users such as, for example, one or several students, teachers, administrators, or the like, and in some aspects, this information can relate to one or several institutional end users such as, for example, one or several schools, groups of schools such as one or several school districts, one or several colleges, one or several universities, one or several training providers, or the like. In some aspects, this information can identify one or several user memberships in one or several groups such as, for example, a student's membership in a university, school, program, grade, course, class, or the like.

The user profile database 301 can include information relating to a user's status, location, or the like. This information can identify, for example, a device a user is using, the location of that device, or the like. In some aspects, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in-is active. In some aspects, the information relating to the user's status can identify whether the user is currently accessing content and/or participating in an activity from the content distribution network 100.

In some aspects, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some aspects, this can include data identifying the type of information accessed through the content distribution network 100 and/or the type of activity performed by the user via the content distribution network 100, the lapsed time since the last time the user accessed content and/or participated in an activity from the content distribution network 100, or the like. In some aspects, this information can relate to a content program comprising an aggregate of data, content, and/or activities, and can identify, for example, progress through the content program, or through the aggregate of data, content, and/or activities forming the content program. In some aspects, this information can track, for example, the amount of time since participation in and/or completion of one or several types of activities, the amount of time since communication with one or several supervisors and/or supervisor devices 110, or the like.

In some aspects in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some aspects, this information can be stored in a tier of memory that is not the fastest memory in the content delivery network 100.

The user profile database 301 can include information relating to one or several student learning preferences. In some embodiments, for example, the user, also referred to herein as the student or the student-user may have one or several preferred learning styles, one or several most effective learning styles, and/or the like. In some aspects, the student's learning style can be any learning style describing how the student best learns or how the student prefers to learn. In one aspect, these learning styles can include, for example, identification of the student as an auditory learner, as a visual learner, and/or as a tactile learner. In some aspects, the data identifying one or several student learning styles can include data identifying a learning style based on the student's educational history such as, for example, identifying a student as an auditory learner when the student has received significantly higher grades and/or scores on assignments and/or in courses favorable to auditory learners. In some aspects, this information can be stored in a tier of memory that is not the fastest memory in the content delivery network 100.

In some aspects, the user profile data store 301 can further include information identifying one or several user skill levels. In some aspects, these one or several user skill levels can identify a skill level determined based on past performance by the user interacting with the content delivery network 100, and in some aspects, these one or several user skill levels can identify a predicted skill level determined based on past performance by the user interacting with the content delivery network 100 and one or several predictive models.

The user profile database 301 can further include information relating to one or several teachers and/or instructors who are responsible for organizing, presenting, and/or managing the presentation of information to the student. In some aspects, user profile database 301 can include information identifying courses and/or subjects that have been taught by the teacher, data identifying courses and/or subjects currently taught by the teacher, and/or data identifying courses and/or subjects that will be taught by the teacher. In some aspects, this can include information relating to one or several teaching styles of one or several teachers. In some aspects, the user profile database 301 can further include information indicating past evaluations and/or evaluation reports received by the teacher. In some aspects, the user profile database 301 can further include information relating to improvement suggestions received by the teacher, training received by the teacher, continuing education received by the teacher, and/or the like. In some aspects, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets) available via the content distribution network 100. In some aspects, these data packets in the content library database 303 can be linked to form an object network. In some aspects, these data packets can be linked in the object network according to one or several sequential relationships which can be, in some aspects, prerequisite relationships that can, for example, identify the relative hierarchy and/or difficulty of the data objects. In some aspects, this hierarchy of data objects can be generated by the content distribution network 100 according to user experience with the object network, and in some aspects, this hierarchy of data objects can be generated based on one or several existing and/or external hierarchies such as, for example, a syllabus, a table of contents, or the like. In some aspects, for example, the object network can correspond to a syllabus such that content for the syllabus is embodied in the object network.

In some aspects, the content library data store 303 can comprise a syllabus, a schedule, or the like. In some aspects, the syllabus or schedule can identify one or several tasks and/or events relevant to the user. In some aspects, for example, when the user is a member of a group such as a section or a class, these tasks and/or events relevant to the user can identify one or several assignments, quizzes, exams, or the like.

In some aspects, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some aspects, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

In some aspects, the content library data store 303 can contain information used in evaluating responses received from users. In some aspects, for example, a user can receive content from the content distribution network 100 and can, subsequent to receiving that content, provide a response to the received content. In some aspects, for example, the received content can comprise one or several questions, prompts, or the like, and the response to the received content can comprise an answer to those one or several questions, prompts, or the like. In some aspects, information, referred to herein as “comparative data,” from the content library data store 303 can be used to determine whether the responses are the correct and/or desired responses.

In some aspects, the content library database 303 and/or the user profile database 301 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some aspects, the content aggregation can comprise a grouping of content comprising the presentation portion that can be provided to the user in the form of, for example, a flash card and an extraction portion that can comprise the desired response to the presentation portion such as for example, an answer to a flash card. In some aspects, one or several content aggregations can be generated by the content distribution network 100 and can be related to one or several data packets that can be, for example, organized in object network. In some aspects, the one or several content aggregations can be each created from content stored in one or several of the data packets.

In some aspects, the content aggregations located in the content library database 303 and/or the user profile database 301 can be associated with a user-creator of those content aggregations. In some aspects, access to content aggregations can vary based on, for example, whether a user created the content aggregations. In some aspects, the content library database 303 and/or the user profile database 301 can comprise a database of content aggregations associated with a specific user, and in some aspects, the content library database 303 and/or the user profile database 301 can comprise a plurality of databases of content aggregations that are each associated with a specific user. In some aspects, these databases of content aggregations can include content aggregations created by their specific user and, in some aspects, these databases of content aggregations can further include content aggregations selected for inclusion by their specific user and/or a supervisor of that specific user. In some aspects, these content aggregations can be arranged and/or linked in a hierarchical relationship similar to the data packets in the object network and/or linked to the object network in the object network or the tasks or skills associated with the data packets in the object network or the syllabus or schedule.

In some aspects, the content aggregation network, and the content aggregations forming the content aggregation network can be organized according to the object network and/or the hierarchical relationships embodied in the object network. In some aspects, the content aggregation network, and/or the content aggregations forming the content aggregation network can be organized according to one or several tasks identified in the syllabus, schedule or the like.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some aspects, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309, can store information relating to one or several predictive models which predictive models can be, for example, statistical models. In some aspects, these can include one or several evidence models, risk models, skill models, or the like. In some aspects, an evidence model can be a mathematically-based statistical model. The evidence model can be based on, for example, Item Response Theory (IRT), Bayesian Network (Bayes net), Performance Factor Analysis (PFA), or the like. The evidence model can, in some aspects, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some aspects, the risk models can include one or several models that can be used to calculate one or several model function values. In some aspects, these one or several model function values can be used to calculate a risk probability, which risk probability can characterize the risk of a user such as a student-user failing to achieve a desired outcome such as, for example, failing to correctly respond to one or several data packets, failure to achieve a desired level of completion of a program, for example in a pre-defined time period, failure to achieve a desired learning outcome, or the like. In some aspects, the risk probability can identify the risk of the student-user failing to complete 60% of the program.

In some aspects, these models can include a plurality of model functions including, for example, a first model function, a second model function, a third model function, and a fourth model function. In some aspects, some or all of the model functions can be associated with a portion of the program such as, for example, a completion stage and/or completion status of the program. In one aspect, for example, the first model function can be associated with a first completion status, the second model function can be associated with a second completion status, the third model function can be associated with a third completion status, and the fourth model function can be associated with a fourth completion status. In some aspects, these completion statuses can be selected such that some or all of these completion statuses are less than the desired level of completion of the program. Specifically, in some aspects, these completion statuses can be selected to all be at less than 60% completion of the program, and more specifically, in some aspects, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some aspects, a model function can be selected from the plurality of model functions based on a student-user's progress through a program. In some aspects, the student-user's progress can be compared to one or several status trigger thresholds, each of which status trigger thresholds can be associated with one or more of the model functions. If one of the status triggers is triggered by the student-user's progress, the corresponding one or several model functions can be selected.

The model functions can comprise a variety of types of models and/or functions. In some aspects, each of the model functions outputs a function value that can be used in calculating a risk probability. This function value can be calculated by performing one or several mathematical operations on one or several values indicative of one or several user attributes and/or user parameters, also referred to herein as program status parameters. In some aspects, each of the model functions can use the same program status parameters, and in some aspects, the model functions can use different program status parameters. In some aspects, the model functions use different program status parameters when at least one of the model functions uses at least one program status parameter that is not used by others of the model functions.

In some aspects, a skill model can comprise a statistical model identifying a predictive skill level of one or several students. In some aspects, this model can identify a single skill level of a student and/or a range of possible skill levels of a student. In some aspects, this statistical model can identify a skill level of a student-user and an error value or error range associated with that skill level. In some aspects, the error value can be associated with a confidence interval determined based on a confidence level. Thus, in some aspects, as the number of student interactions with the content distribution network increases, the confidence level can increase, and the error value can decrease such that the range identified by the error value about the predicted skill level is smaller.

A threshold database 310, also referred to herein as a threshold database, can store one or several threshold values. These one or several threshold values can delineate between states or conditions. In one exemplary aspect, for example, a threshold value can delineate between an acceptable user performance and an unacceptable user performance, between content appropriate for a user and content that is inappropriate for a user, between risk levels, or the like.

In addition to the illustrative data stores described above, data store server(s) 104 (e.g., database servers, file-based storage servers, etc.) may include one or more external data aggregators 311. External data aggregators 311 may include third-party data sources accessible to the content management network 100, but not maintained by the content management network 100. External data aggregators 311 may include any electronic information source relating to the users, content resources, or applications of the content distribution network 100. For example, external data aggregators 311 may be third-party data stores containing demographic data, education-related data, consumer sales data, health-related data, and the like. Illustrative external data aggregators 311 may include, for example, social networking web servers, public records data stores, learning management systems, educational institution servers, business servers, consumer sales data stores, medical record data stores, etc. Data retrieved from various external data aggregators 311 may be used to verify and update user account information, suggest user content, and perform user and content evaluations.

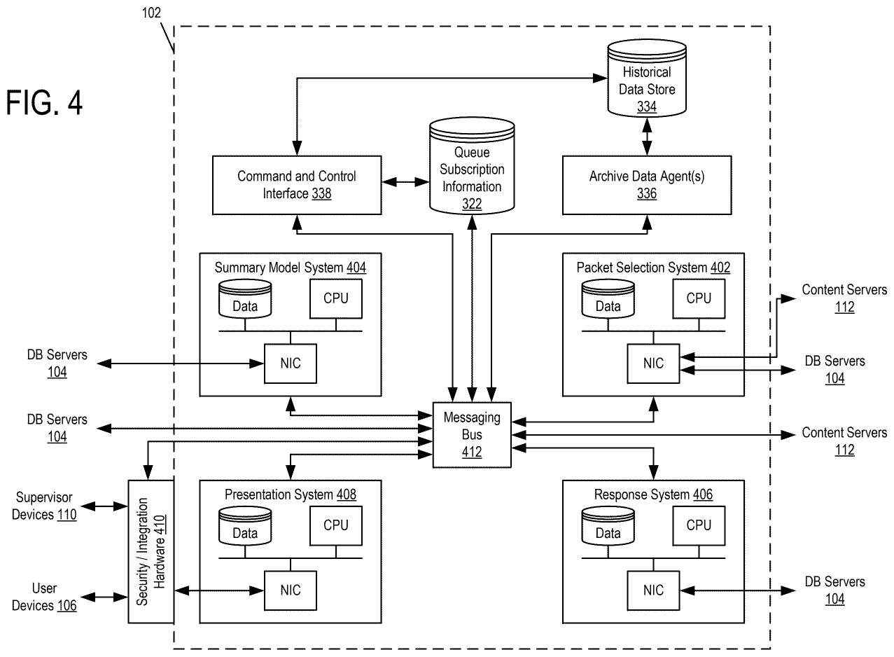

With reference now to FIG. 4, a block diagram is shown illustrating an aspect of one or more content management servers 102 within a content distribution network 100. In such an aspect, content management server 102 performs internal data gathering and processing of streamed content along with external data gathering and processing. Other aspects could have either all external or all internal data gathering. This aspect allows reporting timely information that might be of interest to the reporting party or other parties. In this aspect, the content management server 102 can monitor gathered information from several sources to allow it to make timely business and/or processing decisions based upon that information. For example, reports of user actions and/or responses, as well as the status and/or results of one or several processing tasks could be gathered and reported to the content management server 102 from a number of sources.

Internally, the content management server 102 gathers information from one or more internal components 402-408. The internal components 402-408 gather and/or process information relating to such things as: content provided to users; content consumed by users; responses provided by users; user skill levels; content difficulty levels; next content for providing to users; etc. The internal components 402-408 can report the gathered and/or generated information in real-time, near real-time or along another timeline. To account for any delay in reporting information, a time stamp or staleness indicator can inform others of how timely the information was sampled. The content management server 102 can opt to allow third parties to use internally or externally gathered information that is aggregated within the server 102 by subscription to the content distribution network 100.

A command and control (CC) interface 338 configures the gathered input information to an output of data streams, also referred to herein as content streams. APIs for accepting gathered information and providing data streams are provided to third parties external to the server 102 who want to subscribe to data streams. The server 102 or a third party can design as yet undefined APIs using the CC interface 338. The server 102 can also define authorization and authentication parameters using the CC interface 338 such as authentication, authorization, login, and/or data encryption. CC information is passed to the internal components 402-408 and/or other components of the content distribution network 100 through a channel separate from the gathered information or data stream in this aspect, but other aspects could embed CC information in these communication channels. The CC information allows throttling information reporting frequency, specifying formats for information and data streams, deactivation of one or several internal components 402-408 and/or other components of the content distribution network 100, updating authentication and authorization, etc.

The various data streams that are available can be researched and explored through the CC interface 338. Those data stream selections for a particular subscriber, which can be one or several of the internal components 402-408 and/or other components of the content distribution network 100, are stored in the queue subscription information database 322. The server 102 and/or the CC interface 338 then routes selected data streams to processing subscribers that have selected delivery of a given data stream. Additionally, the server 102 also supports historical queries of the various data streams that are stored in an historical data store 334 as gathered by an archive data agent 336. Through the CC interface 238 various data streams can be selected for archiving into the historical data store 334.

Components of the content distribution network 100 outside of the server 102 can also gather information that is reported to the server 102 in real-time, near real-time or along another timeline. There is a defined API between those components and the server 102. Each type of information or variable collected by server 102 falls within a defined API or multiple APIs. In some cases, the CC interface 338 is used to define additional variables to modify an API that might be of use to processing subscribers. The additional variables can be passed to all processing subscribes or just a subset. For example, a component of the content distribution network 100 outside of the server 102 may report a user response but define an identifier of that user as a private variable that would not be passed to processing subscribers lacking access to that user and/or authorization to receive that user data. Processing subscribers having access to that user and/or authorization to receive that user data would receive the subscriber identifier along with response reported that component. Encryption and/or unique addressing of data streams or sub-streams can be used to hide the private variables within the messaging queues.

The user devices 106 and/or supervisor devices 110 communicate with the server 102 through security and/or integration hardware 410. The communication with security and/or integration hardware 410 can be encrypted or not. For example, a socket using a TCP connection could be used. In addition to TCP, other transport layer protocols like SCTP and UDP could be used in some aspects to intake the gathered information. A protocol such as SSL could be used to protect the information over the TCP connection. Authentication and authorization can be performed to any user devices 106 and/or supervisor device interfacing to the server 102. The security and/or integration hardware 410 receives the information from one or several of the user devices 106 and/or the supervisor devices 110 by providing the API and any encryption, authorization, and/or authentication. In some cases, the security and/or integration hardware 410 reformats or rearranges this received information.

The messaging bus 412, also referred to herein as a messaging queue or a messaging channel, can receive information from the internal components of the server 102 and/or components of the content distribution network 100 outside of the server 102 and distribute the gathered information as a data stream to any processing subscribers that have requested the data stream from the messaging queue 412. As indicate in FIG. 4, processing subscribers are indicated by a connector to the messaging bus 412, the connector having an arrowhead pointing away from the messaging bus 412. Only data streams within the messaging queue 412 that a particular processing subscriber has subscribed to may be read by that processing subscriber if received at all. Gathered information sent to the messaging queue 412 is processed and returned in a data stream in a fraction of a second by the messaging queue 412. Various multi casting and routing techniques can be used to distribute a data stream from the messaging queue 412 that a number of processing subscribers have requested. Protocols such as Multicast or multiple Unicast could be used to distribute streams within the messaging queue 412. Additionally, transport layer protocols like TCP, SCTP and UDP could be used in various aspects.

Through the CC interface 338, an external or internal processing subscriber can be assigned one or more data streams within the messaging queue 412. A data stream is a particular type of message in a particular category. For example, a data stream can comprise all of the data reported to the messaging bus 412 by a designated set of components. One or more processing subscribers could subscribe and receive the data stream to process the information and make a decision and/or feed the output from the processing as gathered information fed back into the messaging queue 412. Through the CC interface 338 a developer can search the available data streams or specify a new data stream and its APL. The new data stream might be determined by processing a number of existing data streams with a processing subscriber.

The CDN 110 has internal processing subscribers 402-408 that process assigned data streams to perform functions within the server 102. Internal processing subscribers 402-408 could perform functions such as providing content to a user, receiving a response from a user, determining the correctness of the received response, updating one or several models based on the correctness of the response, recommending new content for providing to one or several users, or the like. The internal processing subscribers 402-408 can decide filtering and weighting of records from the data stream. To the extent that decisions are made based upon analysis of the data stream, each data record is time stamped to reflect when the information was gathered such that additional credibility could be given to more recent results, for example. Other aspects may filter out records in the data stream that are from an unreliable source or stale. For example, a particular contributor of information may prove to have less than optimal gathered information and that could be weighted very low or removed altogether.

Internal processing subscribers 402-408 may additionally process one or more data streams to provide different information to feed back into the messaging queue 412 to be part of a different data stream. For example, hundreds of user devices 106 could provide responses that are put into a data stream on the messaging queue 412. An internal processing subscriber 402-408 could receive the data stream and process it to determine the difficulty of one or several data packets provided to one or several users, and supply this information back onto the messaging queue 412 for possible use by other internal and external processing subscribers.

As mentioned above, the CC interface 338 allows the CDN 110 to query historical messaging queue 412 information. An archive data agent 336 listens to the messaging queue 412 to store data streams in a historical database 334. The historical database 334 may store data streams for varying amounts of time and may not store all data streams. Different data streams may be stored for different amounts of time.

With regard to the components 402-48, the content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a packet selection system 402. The packet selection system 402 may be implemented using dedicated hardware within the content distribution network 100 (e.g., a packet selection server 402), or using designated hardware and software resources within a shared content management server 102. In some aspects, the packet selection system 402 may adjust the selection and adaptive capabilities of content resources to match the needs and desires of the users receiving the content. For example, the packet selection system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the packet selection system 402 may modify content resources for individual users.

In some aspects, the packet selection system 402 can include a recommendation engine, also referred to herein as an adaptive recommendation engine. In some aspects, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In some aspects, these one or several data packets can be adaptively selected and/or selected according to one or several selection rules. In one aspect, for example, the recommendation engine can retrieve information from the user profile database 301 identifying, for example, a skill level of the user. The recommendation engine can further retrieve information from the content library database 303 identifying, for example, potential data packets for providing to the user and the difficulty of those data packets and/or the skill level associated with those data packets.

The recommendation engine can identify one or several potential data packets for providing and/or one or several data packets for providing to the user based on, for example, one or several rules, models, predictions, or the like. The recommendation engine can use the skill level of the user to generate a prediction of the likelihood of one or several users providing a desired response to some or all of the potential data packets. In some aspects, the recommendation engine can pair one or several data packets with selection criteria that may be used to determine which packet should be delivered to a student-user based on one or several received responses from that student-user. In some aspects, one or several data packets can be eliminated from the pool of potential data packets if the prediction indicates either too high a likelihood of a desired response or too low a likelihood of a desired response. In some aspects, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a summary model system 404. The summary model system 404 may be implemented using dedicated hardware within the content distribution network 100 (e.g., a summary model server 404), or using designated hardware and software resources within a shared content management server 102. In some aspects, the summary model system 404 may monitor the progress of users through various types of content resources and groups, such as media compilations, courses or curriculums in training or educational contexts, interactive gaming environments, and the like. For example, the summary model system 404 may query one or more databases and/or data store servers 104 to retrieve user data such as associated content compilations or programs, content completion status, user goals, results, and the like.

A content management server 102 also may include a response system 406, which can include, in some aspects, a response processor. The response system 406 may be implemented using dedicated hardware within the content distribution network 100 (e.g., a response server 406), or using designated hardware and software resources within a shared content management server 102. The response system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some aspects, the response server 406 may analyze the information to determine the effectiveness or appropriateness of content resources with, for example, a subject matter, an age group, a skill level, or the like. In some aspects, the response system 406 may provide updates to the packet selection system 402 or the summary model system 404, with the attributes of one or more content resources or groups of resources within the network 100. The response system 406 also may receive and analyze user evaluation data from user devices 106, supervisor devices 110, and administrator servers 116, etc. For instance, response system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some aspects, the response system 406 can be further configured to receive one or several responses from the user and analyze these one or several responses. In some aspects, for example, the response system 406 can be configured to translate the one or several responses into one or several observables. As used herein, an observable is a characterization of a received response. In some aspects, the translation of the one or several responses into one or several observables can include determining whether the one or several responses are correct responses, also referred to herein as desired responses, or are incorrect responses, also referred to herein as undesired responses. In some aspects, the translation of the one or several responses into one or several observables can include characterizing the degree to which one or several responses are desired responses and/or undesired responses. In some aspects, one or several values can be generated by the response system 406 to reflect user performance in responding to the one or several data packets. In some aspects, these one or several values can comprise one or several scores for one or several responses and/or data packets.

A content management server 102 also may include a presentation system 408. The presentation system 408 may be implemented using dedicated hardware within the content distribution network 100 (e.g., a presentation server 408), or using designated hardware and software resources within a shared content management server 102. The presentation system 408 can include a presentation engine that can be, for example, a software module running on the content delivery system.

The presentation system 408, also referred to herein as the presentation module or the presentation engine, may receive content resources from the packet selection system 402 and/or from the summary model system 404, and provide the resources to user devices 106. The presentation system 408 may determine the appropriate presentation format for the content resources based on the user characteristics and preferences, and/or the device capabilities of user devices 106. If needed, the presentation system 408 may convert the content resources to the appropriate presentation format and/or compress the content before transmission. In some aspects, the presentation system 408 may also determine the appropriate transmission media and communication protocols for transmission of the content resources.

In some aspects, the presentation system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

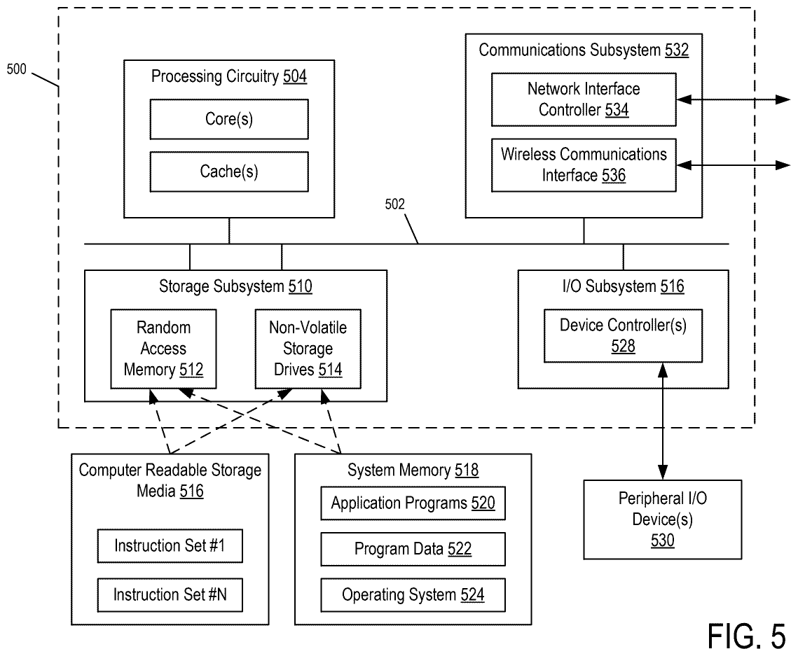

With reference now to FIG. 5, a block diagram of an example computing system 500 is shown. The computing system 500 (e.g., one or more computers) may correspond to any one or more of the computing devices or servers of the distribution computing environment 200, or any other computing devices described herein. In an example, the computing system 500 may represent an example of one or more servers 202 and/or of one or more servers 212 of the distribution computing environment 200. In another example, the computing system 500 may represent an example of the client computing devices 206 of the distribution computing environment 200. In some examples, the computing system 500 may represent a combination of one or more computing devices and/or servers of the distribution computing environment 200.

In some examples, the computing system 500 may include processing circuitry 504, such as one or more processing unit(s), processor(s), etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the computing system 500 may include processing circuitry 504, such as one or more processing units, processors, etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the bus subsystem 502 provides a mechanism for intended communication between the various components and subsystems of computing system 500. Although the bus subsystem 502 is shown schematically as a single bus, alternative embodiments of the bus subsystem may utilize multiple buses. In some examples, the bus subsystem 502 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 526 may include one or more device controller(s) 528 for one or more user interface input devices and/or user interface output devices, possibly integrated with the computing system 500 (e.g., integrated audio/video systems, and/or touchscreen displays), or may be separate peripheral devices which are attachable/detachable from the computing system 500. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 500, such as to a user (e.g., via a display device) or any other computing system, such as a second computing system 500. In an example, output devices may include one or more display subsystems and/or display devices that visually convey text, graphics and audio/video information (e.g., cathode ray tube (CRT) displays, flat-panel devices, liquid crystal display (LCD) or plasma display devices, organic light emitting display (OLED) devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 500 may include one or more storage subsystems 510, including hardware and software components used for storing data and program instructions, such as system memory 518 and computer-readable storage media 516. In some examples, the system memory 518 and/or the computer-readable storage media 516 may store and/or include program instructions that are loadable and executable on the processor(s) 504. In an example, the system memory 518 may load and/or execute an operating system 524, program data 522, server applications, application program(s) 520 (e.g., client applications), Internet browsers, mid-tier applications, etc. In some examples, the system memory 518 may further store data generated during execution of these instructions.

In some examples, the system memory 518 may be stored in volatile memory (e.g., random-access memory (RAM) 512, including static random-access memory (SRAM) or dynamic random-access memory (DRAM)). In an example, the RAM 512 may contain data and/or program modules that are immediately accessible to and/or operated and executed by the processing circuitry 504. In some examples, the system memory 518 may also be stored in non-volatile storage drives 514 (e.g., read-only memory (ROM), flash memory, etc.). In an example, a basic input/output system (BIOS), containing the basic routines that help to transfer information between elements within the computing system 500 (e.g., during start-up), may typically be stored in the non-volatile storage drives 514.

In some examples, the storage subsystem 510 may include one or more tangible computer-readable storage media 516 for storing the basic programming and data constructs that provide the functionality of some embodiments. In an example, the storage subsystem 510 may include software, programs, code modules, instructions, etc., that may be executed by the processing circuitry 504, in order to provide the functionality described herein. In some examples, data generated from the executed software, programs, code, modules, or instructions may be stored within a data storage repository within the storage subsystem 510. In some examples, the storage subsystem 510 may also include a computer-readable storage media reader connected to the computer-readable storage media 516.

In some examples, the computer-readable storage media 516 may contain program code, or portions of program code. Together and, optionally, in combination with the system memory 518, the computer-readable storage media 516 may comprehensively represent remote, local, fixed, and/or removable storage devices plus storage media for temporarily and/or more permanently containing, storing, transmitting, and/or retrieving computer-readable information. In some examples, the computer-readable storage media 516 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information, and which can be accessed by the computing system 500. In an illustrative and non-limiting example, the computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 516 may include, but is not limited to, Zip® drives, flash memory cards, universal serial bus (USB) flash drives, secure digital (SD) cards, DVD disks, digital video tape, and the like. In some examples, the computer-readable storage media 516 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 500.

In some examples, the communications subsystem 532 may provide a communication interface from the computing system 500 and external computing devices via one or more communication networks, LANs, WANs (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. Additionally, and/or alternatively, the communications subsystem 532 may include one or more modems (telephone, satellite, cable, ISDN), synchronous or asynchronous digital subscriber line (DSL) units, Fire Wire® interfaces, USB® interfaces, and the like. Communications subsystem 532 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 532 may also receive input communication in the form of structured and/or unstructured data feeds, event streams, event updates, and the like, on behalf of one or more users who may use or access the computing system 500. In an example, the communications subsystem 532 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 532 may output such structured and/or unstructured data feeds, event streams, event updates, and the like to one or more data stores that may be in communication with one or more streaming data source computing systems (e.g., one or more data source computers, etc.) coupled to the computing system 500. The various physical components of the communications subsystem 532 may be detachable components coupled to the computing system 500 via a computer network (e.g., a communication network 220), a FireWire® bus, or the like, and/or may be physically integrated onto a motherboard of the computing system 500. In some examples, the communications subsystem 532 may be implemented in whole or in part by software.

Due to the ever-changing nature of computers and networks, the description of the computing system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

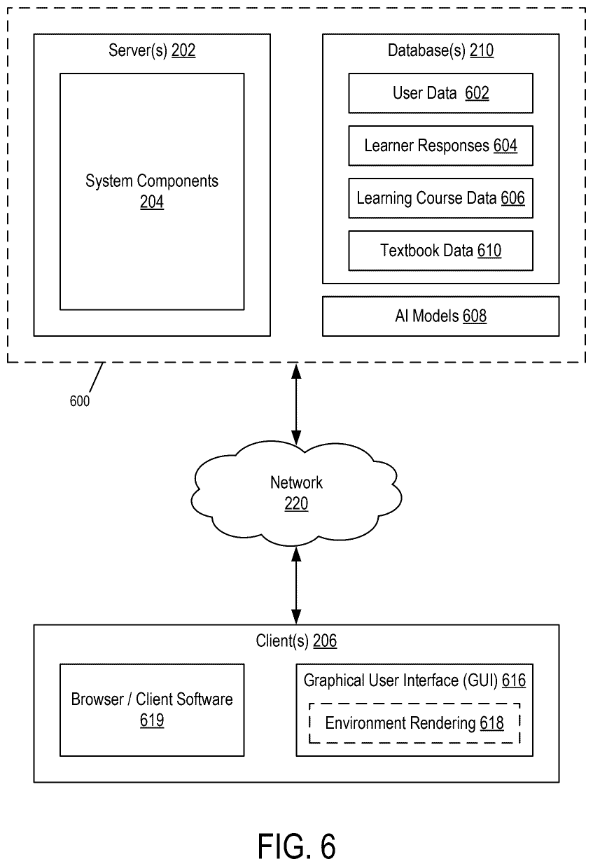

FIG. 6 illustrates a system level block diagram of a video learning environment system 600, such as a system for providing the disclosed artificial intelligence-based video learning environment according to some examples. In some examples, such as where the system 600 is configured to provide individualized and/or customized video learning content, the system 600 may include one or more databases 210, also referred to as data stores herein. The databases 210 may include a plurality of user data 602 (e.g., a set of user data items). In such examples, the system 600 may store and/or manage the user data 602 in accordance with one or more of the various techniques of the disclosure. In some examples, the user data 602 may include user responses, user history, user scores, user performance, user preferences, and the like. In some examples, the system 600 may collect and aggregate some or all user data points from various sources (e.g., platforms, a learner response assessment component, a personalization component, a personalization component, a practice generation component, etc.) to determine characteristics regarding the user. The characteristics regarding the user may be stored in the database 210. In further examples, the characteristics regarding the user may be received by other sources (e.g., third-party components). Database 210 may further store user data 602 about each of one or more learners, possibly enrolled in a class or an organization, and stored as a learner profile for each of the learners. In some embodiments, this data, at a high level, may derive data from a high level for a plurality dimensions and characteristics associated with each of the learners.

As non-limiting examples, this user data 602 regarding each learner may include data derived from, for example, problems within homework, assessments, and/or other assignments. In some aspects, this data may include content from a previous assignment or assessment submitted by the learner. In some aspects, this data may include identification of problems or questions for which the learner has requested help, possibly associated in database 210 with a current or previous assignment or assessment. In some embodiments, this data may include additional data derived by determining a learner's interactions and/or results associated with one or more learning objectives stored in the database 210.

Furthermore, the database 210 may include one or more learner responses 604. In some examples, the learner responses 604 may include multiple interactions of a user, and an interaction may include a spoken response, a written response, a user selection (e.g., via a button in a GUI). In some examples, the learner responses 604 are generated during a chatbot conversation, questions and answers, tests, and other various user activities. In some examples, the learner responses 604 may correspond to previous items, such as completed homework assignments.

The database 210 may include a plurality of learning course data 606. In some aspects, the learning course data 606 may include one or more learning objectives associated with the learning course data 606. The learning objectives may be identified and input into the system 600 by users, such as system administrators, course creators, instructors, etc., possibly via user input into a graphical user interface (GUI) stored on one or more client devices 206.

The system 500 may additionally include one or more artificial intelligence (AI) models 608. In some examples, the AI models 608 can include generative AI models (e.g., large language models (LLMs) and the like); machine learning models (e.g., recurrent neural networks (RNNs), convolutional neural networks (CNNs), deep learning models, transformer models, and the like); sequence-to-sequence models; word embeddings; memory networks; graph neural networks, or any other suitable artificial intelligence model. In further examples, the artificial intelligence models 608 can be stored in a remote or cloud server, which is communicatively coupled to the system server 202 over the network 220.

In some implementations, the database 210 may optionally include textbook data 610. The textbook data may be derived from a physical or electronic textbook, and may include one or more concepts and one or more problems used to assess a user's skill and mastery of those concepts, and/or provide means for the user to improve those skills in order to accomplish specific learning objectives. The textbook data may include embellished data which is not found directly in the corresponding physical or electronic textbook. In some implementations, some or all of the embellished data may be generated by the AI models 608. The textbook data may include problems, solutions, quizzes, and the like. Some or all of the textbook data may be associated with a tag (e.g., metadata, related field in a database, etc.), for example to analyze or categorize the textbook data in relation to other data or to specific learning topics. The use of textbook data 610 may result in more accurate information generated by the AI models 608 and/or reduce instances of hallucination. However, in other implementations the information generated by the AI models 608 may be sufficiently accurate, such that the textbook data 610 is not needed or used.

While FIG. 6 illustrates the database 210 as affirmatively including several different components (e.g., 602-606 and 610), this is merely exemplary and not limiting. In implementations, the database 210 may omit one or more of the components 602-606 and 610 if such components are not used, referenced, or implicated by the system 500.

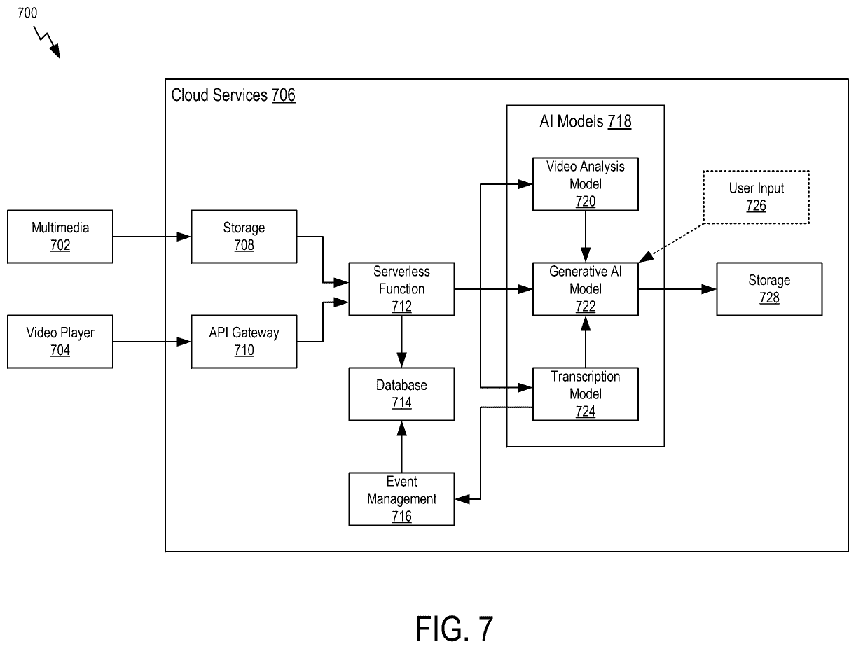

In some aspects of the present disclosure, the server 202 in coordination with the databases 210 may configure the system components 204 (e.g., AI models, which may be stored in the databases 210) for various functions, including, e.g., ingesting a multimedia content; generating additional content (e.g., by one or more AI models); previewing the generated content; receiving modification requests from a user; merging generated content with the content; and the like. Any of the aforementioned functions may be combined, in any combination, by the system 500. For example, the system components 204 may be configured to implement one or more of the functions described below in relation to FIGS. 7 and/or 8.

FIG. 7 illustrates an example communication flow 700 for generating content-rich interactive learning materials according to the present disclosure. Multimedia content 702 and a video player 704 are ingested by a cloud services platform 706. In examples, the multimedia content 702 may include video and/or audio data relating to a learning material (e.g., an educational slideshow presentation, a recording of a lecture, a live broadcast of a class or lesson, etc.). The multimedia content 702 and/or video player 704 may be received from a user (e.g., an instructor, a student, etc.) and/or from a database. The cloud services platform 706 may be a single platform configured to implement the cloud-based functions set forth herein (e.g., Amazon Web Services (AWS) Cloud), or may be multiple platforms that cooperate together to implement the cloud-based functions set forth herein. In some examples, the user may upload the multimedia content 702 to a storage 708 associated with the cloud services platform 706, and the cloud services platform 706 may receive the video player 704 from an external server (e.g., via an application programming interface (API) gateway 710). In examples, the storage 708 may be a cloud-based object storage service, such as Amazon Simple Storage Service (S3). In examples, the API gateway 710 may be a cloud-based API management service, such as Amazon API Gateway.

The multimedia content 702 (either directly or via the storage 708) and the video player 704 may then be input to a serverless function 712. In examples, the serverless function 712 is a cloud-based serverless computing service, such as AWS Lambda. The serverless function 712 may extract various content items from the multimedia content 702 and/or the video player 704 and provide them to other services or microservices. As illustrated, the serverless function 712 may store items in a database 714, which may be a cloud-based storage service, such as Amazon DynamoDB. The serverless function 712 may also provide content items to one or more AI models 718, which may be pre-trained AI models. In other examples, the operations of the serverless function 712 may instead be implemented by provisioning a server.

The AI models 718 include a video analysis model 720, a generative AI model 722, and a transcription model 724. In examples, the video analysis model 720 may be a cloud-based image recognition and video analysis service, such as Amazon Rekognition. In examples, the generative AI model 722 may be a cloud-based service that generates text-, video-, and/or image-based content, such as Amazon Bedrock. It may be used to manage services but may not be required to manage infrastructure. The generative AI model 722 may be configured to implement one or more generative AI services, such as large language models (e.g., Amazon Anthropic Claude). In examples, the transcription model 724 may be a cloud-based automatic speech recognition service configured to extract text from video and/or audio content, such as Amazon Transcribe. The transcription model 724 may thus generate closed captions for the multimedia content 702, a transcript of the multimedia content 702, etc. The output of the transcription model 724 may be provided in one or more file formats, such as an SRT file, a VTT file, and the like.

The transcription model 724 may provide content items to an event management service 716. The event management service 716 may be a serverless scheduler (e.g., a cloud-based serverless event bus), such as Amazon EventBridge. The event management service 716 may be configured to receive one or more events from the transcription model 724 (e.g., as indicated in the file output by the transcription model 724). The events may indicate content points based on the text transcription extracted from the multimedia content 702 by the transcription model 724, such as topics, topic changes, questions, and the like. In some implementations, the event management service 716 may be configured to receive and/or extract timestamps associated with the events. The event management service 716 may be in communication with the database 714, for example to store events, timestamps, and/or associated content items.

The generative AI model 722 may be configured to receive input from the video analysis model 720, the transcription model 724, and (in some implementations) as user input 726, and is configured to generate content (e.g., additional learning content) based on the inputs. For example, the generative AI model 722 may be configured to receive subtitle text in the form of a VTT and/or SRT file from the transcription model 724; to receive labels, keywords, objects, entities, and the like from the video analysis model 720; and/or prompt inputs (e.g., desired difficulty levels, question types, question counts, etc.) from the user input 726. Based on these inputs, the generative AI model 722 generates output and provides the output to a storage 728, which may be the same as the storage 708. The output may include one or more open-ended questions, one or more summaries, one or more multiple-choice questions with associated answers, and the like. In examples, the generative AI model 722 may be configured to present the generated content to the user, who may respond with additional user input 726 (e.g., to request modifications to the generated content). Thus, the generative AI model 722 may use the user input 726 as one or more custom prompts both in the initial generation of output, and in the subsequent refinement or modification of the output.

The particular services described above are merely exemplary and not limiting. The operations of the various cloud services in the cloud services platform 706 may be instead implemented (either entirely or in part) by other services or service providers. However, the examples described above may provide benefits in the context of educational content generation. For example, Amazon Bedrock may be used to provide control to switch models quickly and act as an abstraction layer for the models. Anthropic Claude may provide for complex reasoning and analysis, summarization, multiple-choice classification, and removal of personally identifiable information (PII). The services described above decouple architecture from transcoding, which provides flexibility for input from multiple data sources. Moreover, the use of serverless event driven architecture may provide cost advantages (e.g., by eliminating the need for provisioning and maintaining servers). Using extensively managed services such as those set forth above, dynamic scaling may be provided, and the environmental impact of the backend systems may be reduced.

Several of the components of the cloud services platform 706 described above are implemented using a serverless architecture, providing infrastructure as code. In the example where the cloud services platform 706 is the AWS platform, observability is achieved (e.g., using services such as AWS CloudWatch, X-Ray, etc.). The serverless architecture and event driven architecture itself provides improved performance. For example, individual services of the serverless function 712 may be scaled out by increasing the call rates for the AI services. The example above uses managed regional AI services. In this example, AWS ensures the reliability and availability in the selected AWS region. This inherent nature of managed AWS services is resilient to failure and highly available. Moreover, the described example includes authentication and authorization functions, including encryption at rest for the content in the various storage components (e.g., S3 and DynamoDB). Moreover, AWS Bedrock as an example generative AI model 722 does not use customer data or share content.

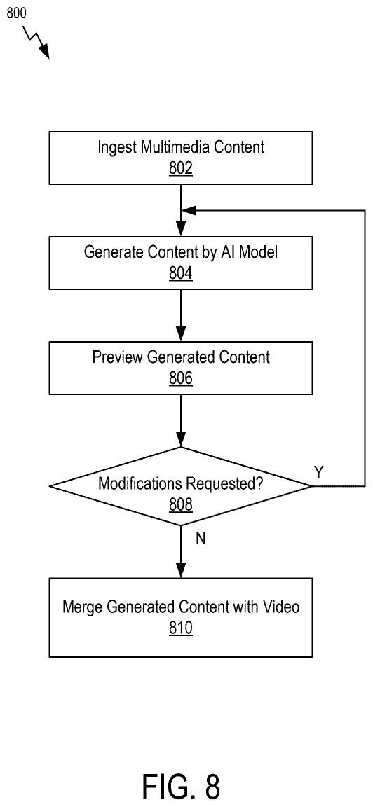

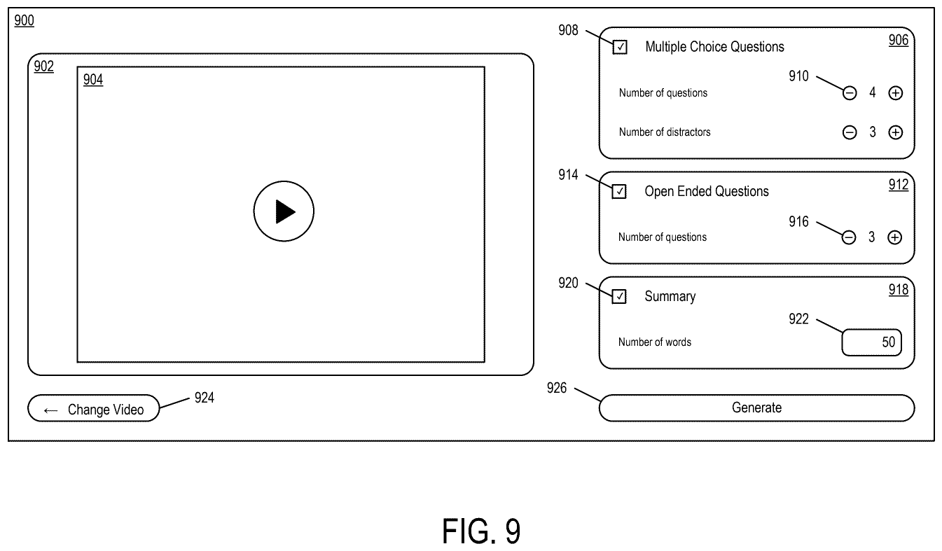

FIG. 8 illustrates an example method 800 for generating AI-based interactive video learning content according to the present disclosure. For purposes of explanation, the method 800 will be described in the context of the particular cloud-based implementation illustrated in FIG. 7; however, the method 800 may be performed by any computing system or set of connected computing systems capable of implementing a cloud services platform. The method 800 includes an operation 802 of ingesting a multimedia content by the cloud services platform. The multimedia content may include a video content and/or an audio content, and may correspond to the multimedia content 702 of FIG. 7. Operation 802 may additionally include ingesting a prompt input from a user. For example, the user may specify a number and/or type of interactive content (e.g., multiple choice questions, open-ended questions, summaries, etc.) that the user would like generated using the method 800. In examples, the prompt input may also specify a difficulty level and/or topic of the desired interactive content. The prompt input may be input by the user using a prompt GUI, one example of which is illustrated in FIG. 9 and will be described in more detail below. Operation 802 may further include ingesting a video player, for example corresponding to the video player 704 of FIG. 7.

At operation 804, at least one AI model of the cloud services platform generates the interactive content based on the prompt input (e.g., in combination with the multimedia content or information derived from the multimedia content. The at least one AI model may include a transcription model (e.g., the transcription model 724), an object recognition model (e.g., the video analysis model 720), and/or a generative AI model (e.g., the generative AI model 722). Operation 804 may include extracting a text content (e.g., a transcript) from the multimedia content using the transcription model. Operation 804 may additionally or alternatively include extracting an object from the multimedia content using the object recognition model (e.g., from the video content). In either case, operation 804 may include generating the interactive content based on the prompt input and the extracted content (i.e., the text content and/or the object) using the generative AI model. For example, if the prompt input specifies that the user desires to create enriched learning content including interactive content in the form of five multiple choice questions, two open-ended questions, and a 75-word summary of the multimedia content, operation 804 may include extracting a text content from the multimedia content, extracting or recognizing a plurality of objects from the multimedia content, providing the extracted content and the desired number and form of interactive content to the generative AI model, and generating the interactive content by the generative AI model based on the received items. Each item of generated interactive content may be associated with a timestamp that corresponds to an embedding time within the multimedia content.

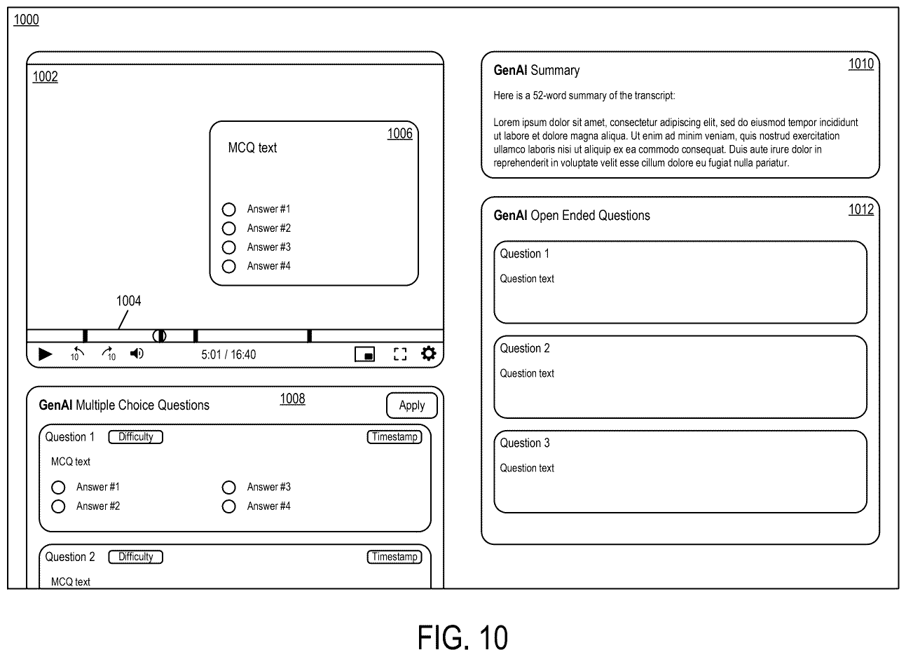

At operation 806, the generated content (i.e., the interactive content) is previewed for the user. Operation 806 may include presenting a preview of the interactive content to the user, for example via a feedback GUI, one example of which is illustrated in FIG. 10 and will be described in more detail below. Operation 806 may include presenting the interactive content to the user, presenting the original multimedia content to the user, and/or presenting a combination of the multimedia content with the interactive content embedded therein to the user. The feedback GUI may present an interface by which the user may review the interactive content and, if desired, request modifications to the interactive content. The modifications may include modifying a content of a question (e.g., modifying an open-ended question, modifying a multiple-choice question, modifying one or more distractors for a multiple choice question), modifying a difficulty level of a question, modifying a topic of a question, modifying an embedding time of a question, modifying a summary of the multimedia content, adding additional interactive content, removing interactive content, and the like.

If, at operation 808, modifications are requested, the method 800 may return to operation 804 to generate revised interactive content. Subsequent iterations of operation 804 may operate similar to the initial iteration of operation 804, except that the subsequent content generation may additionally be based on the feedback received from the user at operation 808 based on the preview. The feedback process may proceed for any number of iterations. By permitting and incorporating feedback, the content generated by the generative AI model may be enhanced and thereby enable improved educational outcomes. If, at operation 808, no modifications are requested, then at operation 810 the generated interactive content is merged with the multimedia content, thereby to produce the enriched learning content. Operation 810 may include embedding the generated interactive content into the multimedia content according to the timestamps. For example, if the interactive content generated at operation 804 includes five multiple choice questions, operation 810 may include embedding a first multiple choice question into the multimedia content at a first timestamp, embedding a second multiple choice question into the multimedia content at a second timestamp, and so on. The embedding may further include metadata or other data configured to cause a video player to pause upon reaching any one of the timestamps, present the question to the learner, await a response from the learner, and resume upon receiving a correct response to (or a request to skip) the question.

In some examples, the system 500 may interact with the client computing device(s) 206 via one or more communication networks 220. In some examples, the client computing device(s) 206 can include at least one GUI 616 to render and/or display environments 618 (e.g., dynamic video learning environments, text entry windows, etc.) for the user. In some examples, the GUI 616 may be generated in part by execution by the client computing device 206 of browser/client software 619 based on data received from the system 500 via the network 220. One example of the GUI 616 that may be generated and interacted with is shown and described further below with respect to FIGS. 9-10. In particular, FIG. 9 illustrates a prompt GUI 900 and FIG. 10 illustrates a feedback GUI 1000, both of which may be presented to an instructor user of the system.

As illustrated, the prompt GUI 900 includes a video panel 902. If multimedia content has not yet been uploaded, the video panel 902 may include a button, which when executed or operated by the instructor, allows the instructor to select a file containing the multimedia content for upload. Additionally or alternatively, the instructor may be able to drag the file into the video panel 902 to cause the upload. If the multimedia content has been uploaded, it may be displayed (e.g., previewed) in video player 904 and a button 924 may appear to permit the user to select a different file for upload.

The prompt GUI 900 further includes a multiple-choice question (MCQ) panel 906. The MCQ panel 906 may include a checkbox 908 that, when selected by the instructor, displays one or more options. In the illustrated example, the options include a number of desired questions and a number of desired distractors for each question. Each option is associated with an input element 910 (as illustrated, plus/minus buttons) by which the instructor may enter a value for each option. In some implementations, the one or more options may always be displayed (e.g., in grayed-out form) even if the checkbox 908 has not been selected.

The prompt GUI 900 further includes an open-ended question (OEQ) panel 912. The OEQ panel 912 may include a checkbox 914 that, when selected by the instructor, displays one or more options. In the illustrated example, the options include a number of desired questions. Each option is associated with an input element 916 (as illustrated, plus/minus buttons) by which the instructor may enter a value for each option. In some implementations, the one or more options may always be displayed (e.g., in grayed-out form) even if the checkbox 914 has not been selected.

The prompt GUI 900 further includes a summary panel 918. The summary panel 918 may include a checkbox 920 that, when selected by the instructor, displays one or more options. In the illustrated example, the options include a desired summary length. Each option is associated with an input element 922 (as illustrated, a text entry box) by which the instructor may enter a value for each option. In some implementations, the one or more options may always be displayed (e.g., in grayed-out form) even if the checkbox 922 has not been selected.

The prompt GUI 900 further includes a button 926 that the instructor may select (e.g., tap, click, etc.) to cause the interactive content to be generated. While FIG. 9 illustrates an example of the various input elements (e.g., checkboxes, text entry fields, buttons, etc.), in practical implementations the various input elements may take any form, including but not limited to checkboxes, radio buttons, drop-down menus, text entry fields, increment buttons, sliders, dials, and the like in any combination. The button 926 may, upon selection, be further configured to cause the system to stop displaying the prompt GUI 900 and begin displaying a feedback GUI.

FIG. 10 illustrates one example of a feedback GUI 1000. The feedback GUI 1000 includes a video player that presents the multimedia content 1002. At a bottom portion of the video player, a toolbar 1004 is presented. The toolbar 1004 presents a plurality of options to the instructor by which the instructor may navigate through the multimedia content 1002. In the illustrated example, the toolbar 1004 includes a play button, a forward skip button, a backward skip button, an audio control button, a current time/total runtime indicator, a popout button, a full screen button, and a settings button; however, this is merely exemplary and not limiting. The illustrated toolbar 1004 further includes a ribbon indicating a current playback position (circle) and the timestamps for each generated question (black bars). If the video player is at a time corresponding to one of the timestamps, the video player presents the interactive content 1006 overlaying the multimedia content 1004.

The feedback GUI 1000 includes a MCQ preview panel 1008 that previews the generated MCQs, including the text and possible answers for each question. The MCQ preview panel 1008 further displays the difficulty level and timestamp for each question. The MCQ preview panel 1008 may be configured to accept feedback in the form of modifications and/or modification requests. These modifications and/or modification requests may include corrections, thereby reducing the occurrence of errors in the generated MCQs (e.g., which may have occurred as a result of hallucinations by the generative AI model used to generate the MCQs). In one example, the instructor may directly edit text within the MCQ preview panel 1008, and may click an “apply” button when editing is complete. In another example, the instructor may remove one or more questions entirely and/or request new or additional questions. In yet another example, the instructor may interact with the MCQ preview panel 1008 via, for example, a chatbot interface.

The feedback GUI 1000 also includes a summary preview panel 1010 that previews the generated summary. The summary preview panel 1010 may be configured to accept feedback in the form of modifications and/or modification requests. In one example, the instructor may directly edit text within the summary preview panel 1010, and may click an “apply” button when editing is complete. In another example, the instructor may request the summary focus on different or additional topic items, and/or may request an entirely new summary. In yet another example, the instructor may interact with the summary panel 1010 via, for example, a chatbot interface.

The feedback GUI 1000 further includes an OEQ preview panel 1012 that previews the generated OEQs, including the text for each question. The OEQ preview panel 1012 may be configured to accept feedback in the form of modifications and/or modification requests. In one example, the instructor may directly edit text within the OEQ preview panel 1012, and may click an “apply” button when editing is complete. In another example, the instructor may remove one or more questions entirely and/or request new or additional questions. In yet another example, the instructor may interact with the OEQ preview panel 1012 via, for example, a chatbot interface.

In examples, the system may further be configured to present the enriched learning content to one or more learner users. In such examples, the enriched learning content may be presented using a learner GUI, which may be the same as the feedback GUI 1000 except that it may not permit the user to modify the questions (i.e., panels corresponding to the MCQ preview panel 1008, summary preview panel 1010, and OEQ preview panel 1012 may not be configured to accept input, may not display items such as difficulty, may not include an “apply” button, and the like).

In some examples, an electronic processor (e.g., of the server(s) 202 or client(s) 206) work in conjunction with the AI models 608 to implement the method 800. For example, the electronic processor may provide the content to the AI model 608 for ingesting (e.g., as described with respect to operation 702). To provide the content, the electronic processor may transmit or cause transmission of the content from one or more sources (e.g., over communication network 220) to the AI model 608. As part of providing the content, the electronic processor may further provide an augmentation prompt. The augmentation prompt may specify details of the request being made of the AI model 608 for generating the additional content. For example, the augmentation prompt may request that the AI model 608 generate one or more of a summary, OEQ problem, MCQ problem, hints, feedback requests, and the like. The augmentation prompt may also specify the format in which the additional content should be generated, the sophistication level for the additional content (e.g., a reading level expected of learner that will use the generated content), among other constraints or request details. The electronic processor may then receive, from the AI model 608, additional content that was generated by the AI model 608 (as described with respect to operation 804). The electronic processor may then store the additional content (e.g., and various corresponding parameters) in a database and/or present the additional content to a user. Similar to as described above, in implementations, certain operations may be performed once, after which other operations may be performed multiple times. The electronic processor may be, for example, implemented similar to the processing circuitry 504 described with respect to FIG. 5, and may include one or more processors, one or more processor cores, and/or one or more processing elements that are co-located, located separately from one another, or a combination thereof.

As noted above, the method 800, as well as operations and sub-operations thereof, may be implemented by various devices. For example, an electronic processor (e.g., of the system 500, the server(s) 202, or the client device(s) 206) may implement the method 800, operations of the method 800, and/or sub-operations of the method and 800. Such an electronic processor may be, for example, implemented similar to the processing circuitry 504 described with respect to FIG. 5, and may include one or more processors, one or more processor cores, and/or one or more other processing elements, that are co-located, located separately from one another, or a combination thereof). As described with respect to the processing circuitry 504, to implement these and other functions, the electronic processor may retrieve and execute software and/or include particularly configured hardware.

In examples, a user (e.g., an instructor or author) may first generate a video file. For example, the user may record a lecture, may retrieve a prerecorded lecture from a database, may initiate a livestream of a lecture, and the like. The user may then use the systems and/or methods set forth herein to generate content for interactive video learning. The user may generate the content by uploading file corresponding to the lecture to be ingested by a system (e.g., the system 600 described above) that uses one or more AI models to automatically generate preliminary content. The system may be accessed by the user via a GUI, which presents the user with a variety of options for generating the content. In an example, the GUI may be the same as or similar to the GUI 900 illustrated in FIG. 9. Based on the options selected by the user via the GUI and/or other user inputs (e.g., default user preferences, organizational standards, etc.), the system may generate a set of preliminary content. The preliminary content may include MCQs, OEQs, timestamp-based questions, summaries, etc.

The system may then present the preliminary content to the user for preliminary review, thereby to permit the user to implement a review workflow, for example to review, modify, and/or attach questions to the video. In examples, the GUI may switch display to a new screen, which may be the same as or similar to the GUI 1000 illustrated in FIG. 10. This presents the preliminary content along with a series of UI elements by which the user may modify one or more aspects of the preliminary content. If a modification is requested, the system may re-generate the preliminary content and present it for user review. This modification may proceed in an iterative manner until the user is satisfied with the preliminary content. The GUI may further include an option to approve the preliminary content, for example if no modification is desired. Once approved, the preliminary content may be combined with the uploaded video data to generate enriched content, that may be presented (either in real-time or at a later point) to one or more additional users (e.g., learners), may be stored in a database, and the like. The procedures for generating the enriched content provide significant time savings for the user, and in implementations result in a lower utilization of computing resources (e.g., processor resources, memory resources, etc.). Moreover, the system provides for increased personalization by granting the user the ability to provide feedback before the enriched content is generated, thereby permitting the user to tailor content to diverse student needs and learning levels and improving the quality and effectiveness of the enriched content. The feedback process may provide for a review workflow that results in improvements to the generated content. The AI-driven enriched content may increase learner engagement in the interactive video learning environment, thus leading to improved educational outcomes.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

What is claimed is:

1. A method of generating an enriched learning content, the method comprising:
ingesting, by a cloud services platform, a multimedia content, wherein the multimedia content includes a video content;
generating, by at least one artificial intelligence (AI) model of the cloud services platform and based on a prompt input from a user, an interactive content;
presenting a preview of the interactive content to the user; and
merging the multimedia content and the interactive content to produce the enriched learning content.

2. The method of claim 1, further comprising:
receiving a feedback from the user based on the preview; and
modifying the interactive content in response to the feedback.

3. The method of claim 1, wherein the interactive content includes at least one of a multiple-choice question, an open-ended question, or a summary.

4. The method of claim 1, wherein
the at least one AI model includes a transcription model and a generative AI model; and
generating the interactive content includes:
extracting, using the transcription model, a text content from the multimedia content, and
generating, using the generative AI model and based on the prompt input and the text content, the enriched learning content.

5. The method of claim 1, wherein
the at least one AI model includes an object recognition model and a generative AI model; and
generating the interactive content includes:
extracting, using the object recognition model, an object from the video content, and
generating, using the generative AI model and based on the prompt input and the object, the enriched learning content.

6. The method of claim 1, further comprising:
ingesting, by an application programming interface (API) of the cloud services platform, a video player; and
presenting the enriched learning content to a learner via the video player.

7. The method of claim 1, wherein
the interactive content includes a timestamp corresponding to an embedding time within the multimedia content; and
merging the multimedia content and the interactive content includes embedding the interactive content into the multimedia content according to the timestamp.

8. A system for generating an enriched learning content, the system comprising:
a memory; and
a processor coupled with the memory, wherein the processor is configured to:
ingest, by a cloud services platform in communication with the processor and the memory, a multimedia content, wherein the multimedia content includes a video content;
generate, by at least one artificial intelligence (AI) model of the cloud services platform and based on a prompt input from a user, an interactive content;
present a preview of the interactive content to the user; and
merge the multimedia content and the interactive content to produce the enriched learning content.

9. The system of claim 8, wherein the processor is further configured to:
receive a feedback from the user based on the preview; and
modify the interactive content in response to the feedback.

10. The system of claim 8, wherein the interactive content includes at least one of a multiple-choice question, an open-ended question, or a summary.

11. The system of claim 8, wherein
the at least one AI model includes a transcription model and a generative AI model; and
generating the interactive content includes:
extracting, using the transcription model, a text content from the multimedia content, and
generating, using the generative AI model and based on the prompt input and the text content, the enriched learning content.

12. The system of claim 8, wherein
the at least one AI model includes an object recognition model and a generative AI model; and
generating the interactive content includes:
extracting, using the object recognition model, an object from the video content, and
generating, using the generative AI model and based on the prompt input and the object, the enriched learning content.

13. The system of claim 8, wherein the processor is further configured to:
ingest, by an application programming interface (API) of the cloud services platform, a video player; and
present the enriched learning content to a learner via the video player.

14. The system of claim 8, wherein
the interactive content includes a timestamp corresponding to an embedding time within the multimedia content; and
merging the multimedia content and the interactive content includes embedding the interactive content into the multimedia content according to the timestamp.

15. A non-transitory computer-readable medium storing instructions that, when executed by a processor of a computing node associated with a cloud services platform, cause the computing node to perform operations comprising:
ingesting, by a cloud services platform, a multimedia content, wherein the multimedia content includes a video content;
generating, by at least one artificial intelligence (AI) model of the cloud services platform and based on a prompt input from a user, an interactive content;
presenting a preview of the interactive content to the user; and
merging the multimedia content and the interactive content to produce the enriched learning content.

16. The non-transitory computer-readable medium of claim 15, the operations further comprising:
receiving a feedback from the user based on the preview; and
modifying the interactive content in response to the feedback.

17. The non-transitory computer-readable medium of claim 15, wherein the interactive content includes at least one of a multiple-choice question, an open-ended question, or a summary.

18. The non-transitory computer-readable medium of claim 15, wherein
the at least one AI model includes a transcription model and a generative AI model; and
generating the interactive content includes:
extracting, using the transcription model, a text content from the multimedia content, and
generating, using the generative AI model and based on the prompt input and the text content, the enriched learning content.

19. The non-transitory computer-readable medium of claim 15, wherein
the at least one AI model includes an object recognition model and a generative AI model; and
generating the interactive content includes:
extracting, using the object recognition model, an object from the video content, and
generating, using the generative AI model and based on the prompt input and the object, the enriched learning content.

20. The non-transitory computer-readable medium of claim 15, wherein
the interactive content includes a timestamp corresponding to an embedding time within the multimedia content; and
merging the multimedia content and the interactive content includes embedding the interactive content into the multimedia content according to the timestamp.
